(19) United States
(12) Patent Application Publication
(10) Pub. No.: US 2010/0000214 A1
(43) Pub. Date: Jan. 7, 2010

(54) Petroleum-based Thermoelectric Energy Conversion System

(75) Inventors: Nicholas J. Nagurny, Manassas, VA (US); Natalie Levings, Palm Beach Gardens, FL (US); Lance Greer, Nokesville, VA (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/495,943

(22) Filed: Jul. 1, 2009

Related U.S. Application Data
(60) Provisional application No. 61/078,202, filed on Jul. 3, 2008.

(51) Int. Cl. F03G 4/00

(52) U.S. Cl. 60/641.2

(57) ABSTRACT

A system for generating electrical energy based on a temperature differential between petroleum products extracted from a geothermal reservoir and water from a region of a body of water is disclosed. Some embodiments comprise a submerged pump and a submerged OTEC system, wherein the OTEC system provides locally generated electrical energy to the pump.

### CROSS REFERENCE TO RELATED APPLICATIONS

This case claims priority to: U.S. Provisional Patent Application Ser. No. 61/078,202, filed Jul. 3, 2008 (Attorney Docket: 711-214US), which is incorporated by reference.

In addition, the underlying concepts, but not necessarily the language, of the following cases are incorporated by reference:
(1) U.S. patent application Ser. No. 12/396,349, filed Mar. 2, 2009 (Attorney Docket: 711-260US); and
(2) U.S. patent application Ser. No. 12/411,824, filed Mar. 26, 2009 (Attorney Docket: 711-263US).

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to pump systems in general, and, more particularly, to petroleum pumping systems.

### BACKGROUND

As energy concerns grow, the cost-benefit ratio of petroleum exploration in difficult-access regions becomes more favorable. As a result, oil and natural gas exploration and extraction in remote areas is becoming more common.

A challenge associated with extraction of oil and natural gas in remote areas is powering the drilling and pumping equipment when there is no convenient means of providing electricity. The challenge of powering pumping equipment is exacerbated at deep-sea platforms where the pumps are ideally located at the well-heads themselves—often five or more miles below the ocean surface.

In some conventional deep-sea platforms, well pumps are located at the floating platform itself, thereby obviating the need to convey electrical energy to the seabed. Unfortunately, pumps located at the platform are less mechanically efficient. As a result, such a pump configuration increases operating costs as well as mechanical complexity.

In some conventional deep-sea platforms, electrical cables are run from diesel-based electrical generators located at the surface platform to submerged well pumps located on the ocean floor. This configuration has several drawbacks, however. First, diesel-based electrical generators produce CO₂ and assorted other pollutants. Second, these electrical cables are subject to damage from marine life, underwater currents, and stresses induced by weather disturbances. Third, the electrical efficiency of such a system is degraded by the long transmission distance from the surface platform to the sea bed pumps.

There exists a need, therefore, for a petroleum pumping system that mitigates some or all of the problems associated with the prior art.

### SUMMARY OF THE INVENTION

The present invention provides a geo-thermal energy generation system that generates electrical energy based on a temperature differential between extracted petroleum products and a deep water layer. Some embodiments of the present invention are particularly well-suited for providing local electrical energy to submerged well pumps included in off-shore oil and gas production systems.

In some embodiments, an energy generation system comprises an energy conversion unit that includes a first heat exchanger, a second heat exchanger, and an energy conversion system for converting a temperature difference into electrical energy. The electrical energy is generated local to well pumps located at the ocean floor. In some embodiments, a closed-loop fluid system thermally couples a conduit carrying hot petroleum products and a hot zone of the first heat exchanger. The second heat exchanger comprises a cold zone that is thermally coupled to water in a deep-water region that acts as a heat sink for the heat exchanger. Preferably, the deep-water region exhibits a high heat capacity and a temperature that is substantially constant regardless of latitude, weather conditions, the annual solar cycle, or even the daily solar cycle. The energy conversion system interposes the first heat exchanger and the second heat exchanger and generates electrical energy based on the temperature differential between the hot zone of the first heat exchanger and the cold zone of the second heat exchanger.

In some embodiments, the energy conversion system comprises a Rankin-cycle engine that is thermally coupled to the hot petroleum products and the cold water in a deep-water region.

In some embodiments, the energy conversion system comprises a solid-state thermo-electric element that generates electrical energy by means of the Peltier effect. the energy conversion system comprises a quantum-well thermo-electric element.

In some embodiments, the energy conversion system removes enough heat from the petroleum products that flow through a conduit thermally coupled to the hot zone that the corrosive nature of the oil and/or natural is sufficiently reduced to obviate the need that the conduit comprises expensive corrosive-resistant materials.

An embodiment of the present invention comprises an apparatus for pumping petroleum products from a subterranean reservoir comprising: a first pump, wherein the first pump pumps the petroleum products from the subterranean reservoir, and wherein the first pump is physically adapted for operation in deep sea conditions; and a generator comprising a hot zone that is thermally coupled to a subterranean geothermal heat source, a cold zone that is thermally coupled to a first region of a body of water, and an energy conversion system that generates electrical energy based on a temperature differential between the hot zone and the cold zone; wherein the generator provides electrical energy to the first pump.

### BRIEF DESCRIPTION OF THE DRAWINGS

FIG. 1 depicts a schematic diagram of details of a prior-art geothermal energy conversion system.

FIG. 2 depicts a schematic diagram of a portion of a representative OTEC power generation system in accordance with the prior art.

FIG. 3 depicts a schematic diagram of details of a petroleum production system in accordance with an illustrative embodiment of the present invention.

FIG. 4 depicts a method for pumping petroleum products in accordance with the illustrative embodiment of the present invention.

FIG. 5 depicts a schematic diagram of details of a self-powered pump system in accordance with the illustrative embodiment of the present invention.

FIG. 6 depicts calculated efficiencies of energy conversion cycles versus temperature differential for an energy conversion system in accordance with the present invention.

FIG. 7 depicts a schematic diagram of details of a self-powered pump system in accordance with a first alternative embodiment of the present invention.

FIG. 8 depicts a schematic diagram of details of a self-powered pump system in accordance with a second alternative embodiment of the present invention.

### DETAILED DESCRIPTION

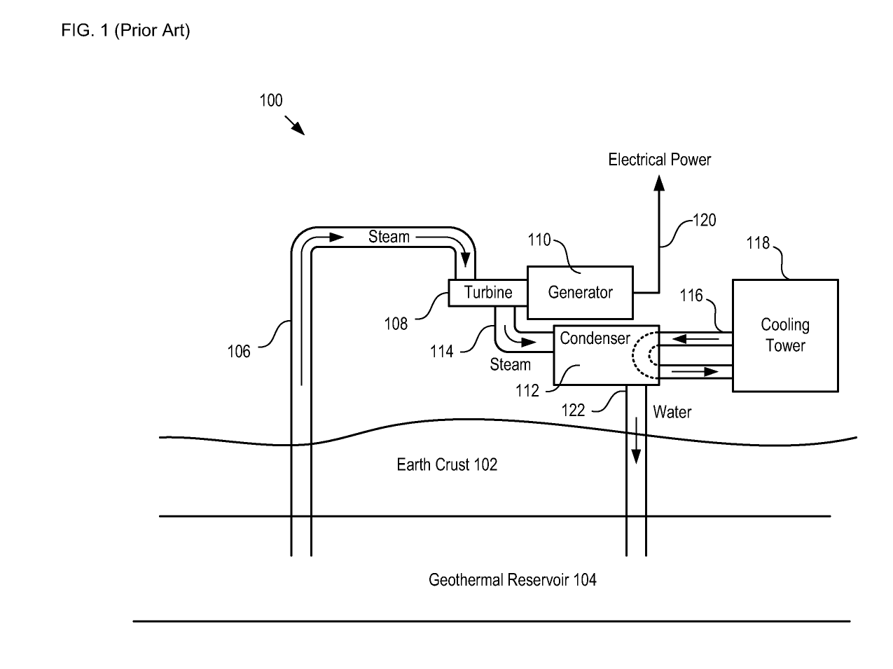

FIG. 1 depicts a schematic diagram of details of a prior-art geothermal energy conversion system. Energy system 100 comprises inlet pipe 106, turbine 108, generator 110, condenser 112, couplings 114 and 116, cooling tower 118, and outflow pipe 122. In some embodiments, a water pump is coupled to the outflow of condenser 112 to drive the return water to greater depths or to facilitate flow in a very long or narrow outflow pipe 122.

In operation, steam from geothermal reservoir 104, which resides below earth crust 102, is conveyed to turbine 108 by inlet pipe 106. The steam turns turbine blades within the turbine. Turbine 108 is operatively coupled to generator 110. As turbine 108 turns generator 110, the generator produces electrical energy. This electrical energy is conveyed to an end user on output cable 120.

As the steam passes through turbine 108, it is conveyed to condenser 112 via coupling 114. At condenser 112, the steam is cooled by refrigerant fluid that circulates through coupling 116 to and from cooling tower 118. The steam then condenses into water within condenser 112. The condensate is conveyed back to geothermal reservoir 104 via outlet pipe 122. Cooling tower 118 releases heat by vaporizing water into the atmosphere cooling the refrigerant fluid before it is conveyed to the condenser 112.

There are several problems with conventional direct geothermal systems, such as energy system 100. First, the steam and/or hot water from the geothermal source is highly corrosive, which limits the lifetime of the turbine. Second, atmospheric temperature acts as the heat sink for conventional geothermal systems. The power generation capacity of a conventional geothermal system decreases as the ambient temperature at the turbine increases. This is due to the fact that the power generation is directly related to the temperature differential of the system. To further exacerbate matters, the reduction in power generation capacity tends to occur at times when such power is needed most (e.g., when it is hot out and air conditioning demand increases, etc.) Further, latitude and seasonal temperature variation cause variability in the power generation capability of these systems.

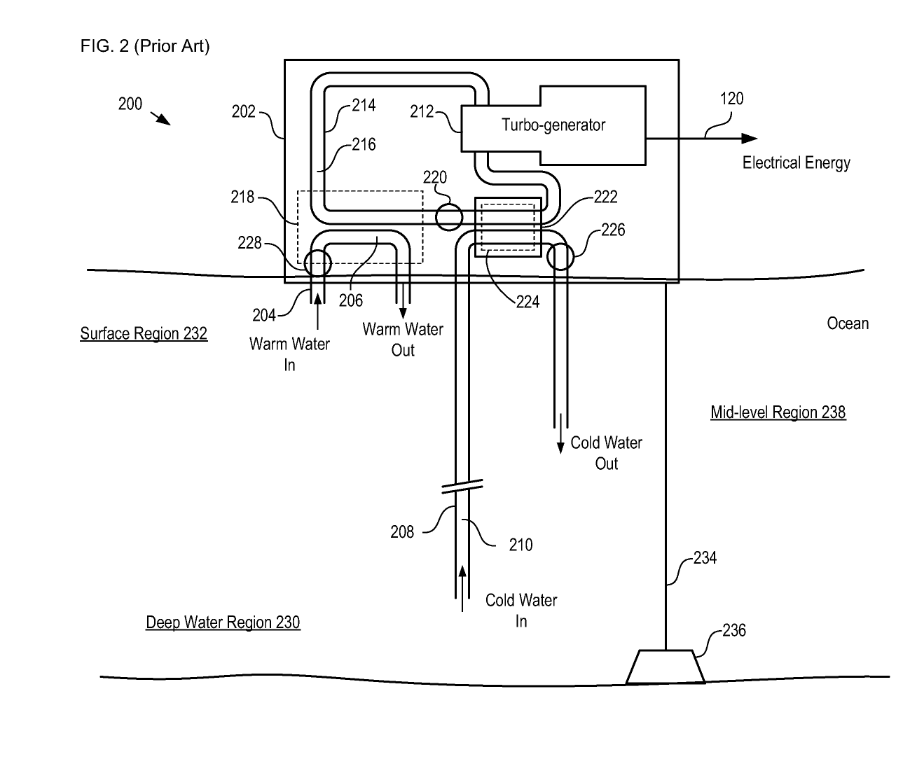

FIG. 2 depicts a schematic diagram of a portion of a representative OTEC power generation system in accordance with the prior art. OTEC system 200 comprises platform 202, surface water conduit 204, deep water conduit 208, turbogenerator 212, closed-loop conduit 214, heat exchanger 218, pump 220, and condenser 222.

Platform 202 is a conventional floating energy-plant platform. Platform 202 is anchored to the ocean floor by mooring line 234, which is connected to anchor 236. Anchor 236 is embedded in the ocean floor. In some instances, platform 202 is not anchored to the ocean floor and platform 202 is allowed to drift. Such a system is sometimes referred to as a “grazing plant.” In other cases, platform 202 is a tension-leg platform, which is supported above the ocean floor by means of a plurality of rigid legs.

Surface water conduit 204 is a large-diameter conduit suitable for conveying relatively warmer water from surface region 232 into heat exchanger 218. Surface water is pumped through conduit 204 by pump 228.

Closed-loop conduit 214 is a closed-circuit loop of conduit that contains working fluid 216. Ammonia is one commonly used working fluid; however, many other fluids can be suitably used as working fluid 214.

Closed-loop conduit 214 and surface water conduit 204 are thermally coupled at heat exchanger 218. As a result, working fluid 216 (e.g., ammonia) and surface water 206 are thermally coupled at heat exchanger 218, where the heat of surface water 206 vaporizes working fluid 216. The expanding vapor drives turbogenerator 212, which rotates to generate electrical energy, which is provided on output cable 120.

After the vaporized working fluid passes through turbogenerator 212, it enters condenser 222, which comprises heat exchanger 224. At heat exchanger 224, the vaporized working fluid 216 in closed-loop conduit 214 and cold water 210 flowing through deep water conduit 208 are thermally coupled. Cold water 210 is drawn from deep water region 230 by pump 226. Typically, deep water region 230 is 1000+ meters below the surface of the body of water. Water at this depth is at a substantially constant temperature of a few degrees centigrade.

Cold water 210 absorbs heat from vaporized working fluid 216 at heat exchanger 224, thereby cooling working fluid 216 so that it condenses back into its liquid state. Pump 220 recycles the condensed working fluid 216 back into heat exchanger 218 where it is vaporized again to continue the cycle that drives turbogenerator 212.

After passing through heat exchanger 224, cold water 210 is ejected into mid-level region 238 to avoid cooling the surface water near platform 202.

Conventional OTEC systems have several drawbacks. First, it is difficult and energy intensive to pump cold water up from depths of 1000+ meters. This challenge is further exacerbated by the fact that cold water is more dense than warm water, which increases the energy required to draw it up to the surface. This significantly increases the cost and reduces the benefits of using an OTEC approach for power generation.

Second, for an OTEC generation system capable of generating 10's to 100's of megawatts, deep water conduit 208 typically has a diameter within the range of 3-10 meters and a length greater than 1000 meters. Such a conduit is difficult and expensive to manufacture.

Third, the size and length of deep water conduits makes them susceptible to damage from environmental conditions, such as strong currents, storms, and wave action. As a result, complicated and expensive infrastructure is required to protect these conduits from damage. For example, numerous recent efforts have been made to improve the reliability of cold water conduits. These include the development of flexible conduits, inflatable conduits, rigid conduits made from steel, plastics, and composites, and gimbal-mounted conduits. Even with such proposed innovations, long cold water conduits remain a significant reliability and cost issue.

The present invention exploits some of the benefits of conventional OTEC systems to power a petroleum pumping facility while avoiding some of the drawbacks of conventional OTEC. Embodiments of the present invention comprise an OTEC power generation system that is submerged in a deep water region of a large body of water (e.g., at the ocean floor) adjacent to a petroleum well head. The OTEC system generates electrical energy based on the temperature differential between a petroleum conduit coupled to the well head and the water in the deep water region. The electrical energy is used locally, at the well head, to power pumps that pump petroleum products to the surface through the conduit.

Systems in accordance with the present invention can operate with high conversion efficiency due to the high temperature of the petroleum products in the conduit and the stable low temperature of deep-level water. Further, the proximity of the OTEC system and the pump that it powers affords cost and reliability advantages to embodiments of the present invention over prior-art systems.

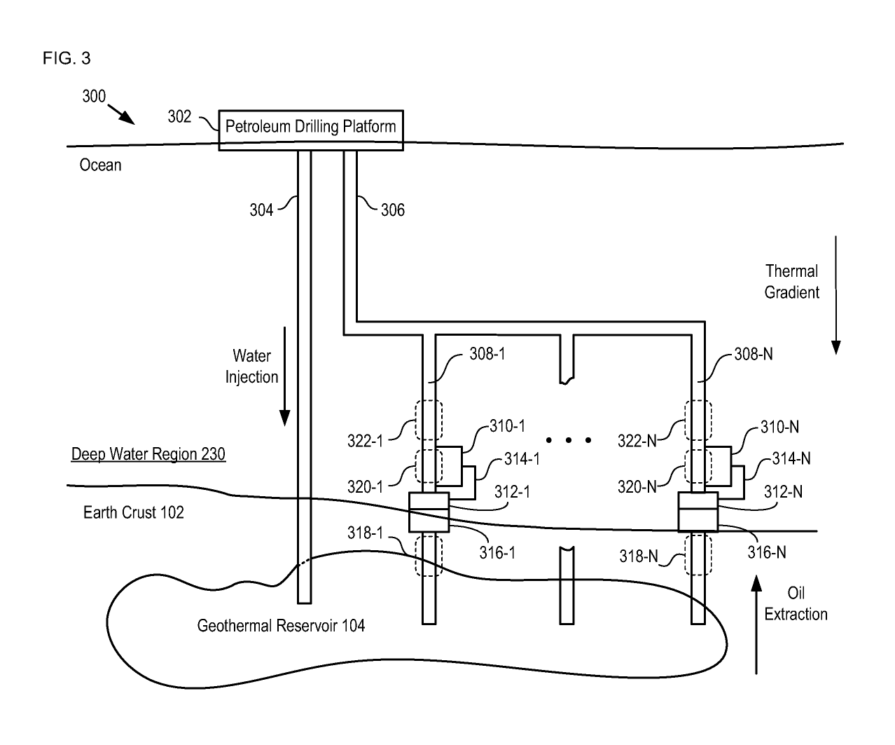

FIG. 3 depicts a schematic diagram of details of a petroleum production system in accordance with an illustrative embodiment of the present invention. Production system 300 comprises platform 302, optional water conduit 304, petroleum conduit 306, feeder conduits 308-1 through 308-N, well-heads 316-1 through 316-N, energy conversion systems 310-1 through 310-N, and pumps 312-1 through 312-N. Production system 300 is described herein as an oil extraction system, although the present invention is equally suitable for extracting natural gas from geothermal reservoir 104. The number, N, of well-heads 316 that tap into reservoir 104 is based on the size of reservoir 104, desired production capacity for the pumping system. One skilled in the art, after reading this specification, will be able to determine a suitable number of well-heads for a production system in accordance with the present invention.

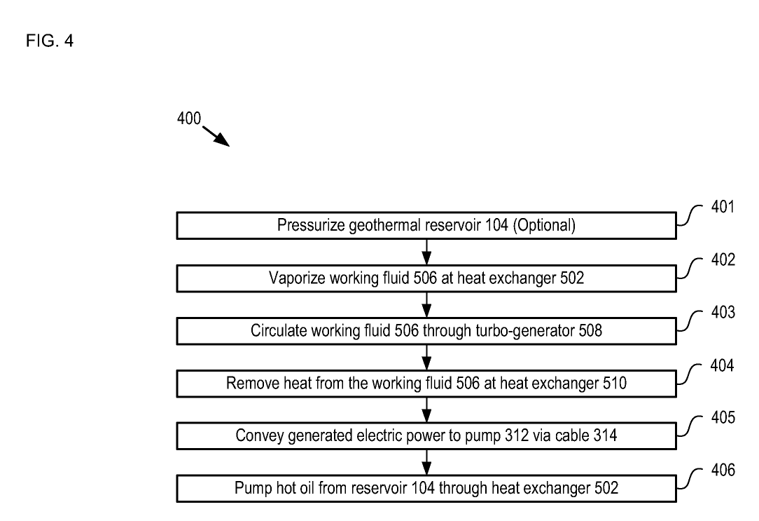

FIG. 4 depicts a method for pumping petroleum products in accordance with the illustrative embodiment of the present invention. Method 400 is described herein with continuing reference to FIG. 3.

Method 400 begins with optional operation 401, wherein pressure in geothermal reservoir 104 in increased by injecting water into the reservoir through water conduit 304. In response to the injection of water into the reservoir, oil is force upward through regions 318-1 through 318-N and into regions 320-1 through 320-N of feeder conduits 308-1 through 308-N. The hot oil heats the conduit walls in regions 320-1 through 320-N.

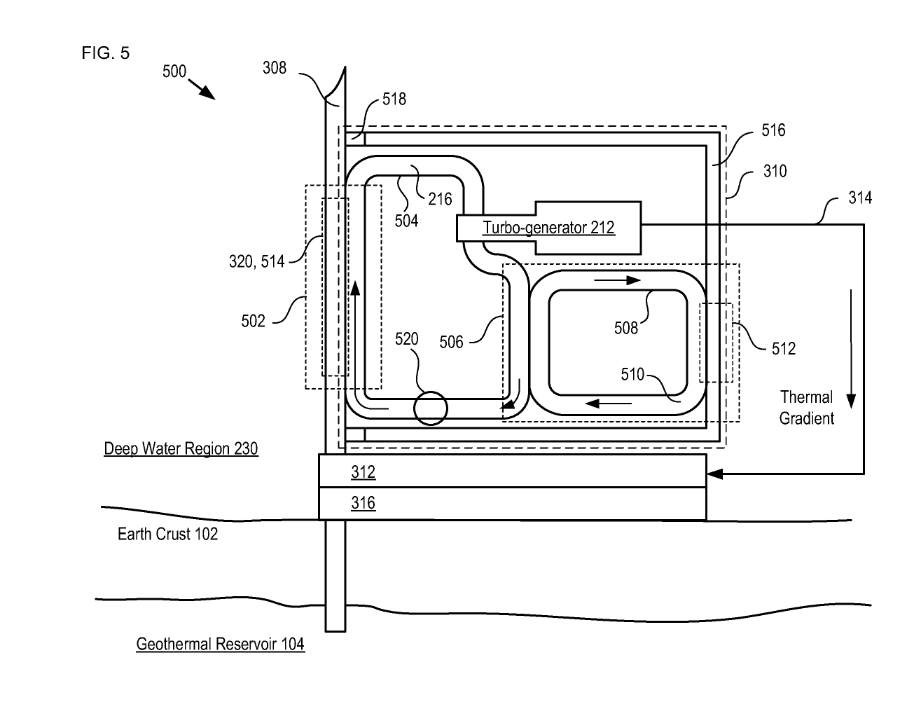

Each of energy conversion systems 310-1 through 310-N is a substantially identical OTEC energy conversion system that is coupled to each of feeder conduits 308 near its well-head 316. A representative energy conversion system 310 is described in detail below, and with respect to FIG. 5.

Each of pumps 312-1 through 312-N is a substantially identical pump 312 that is disposed at one of well-heads 316-1 through 316-N that are located on the ocean floor. Each pump 312 is adapted for operation in deep-water region 230. Each pump 312 is powered by electrical energy generated by a corresponding energy conversion system 310. Each pump 312 and its corresponding energy conversion system 310 collectively define a self-powered petroleum pump system. In some embodiments, one or more energy conversion system 310 is augmented by an alternative power supply, such as a battery system.

FIG. 5 depicts a schematic diagram of details of a self-powered pump system in accordance with the illustrative embodiment of the present invention. Pump system 500 comprises one energy conversion system 310 and one pump 312. In some embodiments, pump system 500 comprises one energy conversion system 310 and more than one pump 312, wherein the energy system provides electrical energy to each of the plurality of pumps.

Energy conversion system 310 is an OTEC system that comprises heat exchanger 502, closed-loop conduit 504, turbogenerator 212, heat exchanger 506 and pressure hull 516. Heat exchanger 502, closed-loop conduit 504, turbogenerator 212, and heat exchanger 506 collectively define a Rankine-cycle engine.

Pressure hull 516 is a shell of structural material with sufficient strength to withstand the pressures that exist at deep water levels. It encloses and protects heat exchanger 502, closed-loop conduit 504, turbogenerator 212, and heat exchanger 506. Hull 516 is thermally isolated from feeder conduit 308 by thermal isolators 518. The specific design of hull 516 is based upon the intended application and deployment depth. For example, a pressure hull intended to be deployed at a depth of 1000 meters must be able to withstand water pressure that exceeds 100 atmospheres. In addition, hull 516 comprises an electrical feed-through for cable 314. In some embodiments, hull 516 also encloses and protects pump 312. In some embodiments, enclosure of pump 312 within hull 516 enables the pump to operate at depths greater than 1000 meters.

Heat exchanger 502 comprises hot zone 514 and a portion of closed-loop conduit 504. Hot zone 514 is region 320 of feeder conduit 308, which is thermally coupled with closed-loop conduit 504. As a result, at heat exchanger 502, working fluid 216 is thermally coupled with geothermal reservoir 104.

At operation 402, heat in the conduit wall of region 320 (i.e., hot zone 514) vaporizes the working fluid 216 in closed-loop conduit 504. The vaporized working fluid flows clock-wise through closed-loop conduit 504 to turbogenerator 212. In some embodiments, a pump is included to induce or enhance circulation of working fluid 216 through conduit 504.

At operation 403, vaporized working fluid 216 circulates through turbogenerator 212 causing it to rotate and generate electrical energy.

At operation 404, vaporized working fluid 216 circulates from turbogenerator 212 to heat exchanger 506, which acts as a condenser. At heat exchanger 506, working fluid 510 sinks heat from working fluid 216 by virtue of the thermal coupling of closed-loop conduit 504 and cooling conduit 508. As a result, vaporized working fluid 216 cools and condenses back into its liquid state. The condensed working fluid 216 is then pumped back to heat exchanger 502 by pump 520. Pump 520 is powered by electrical energy provided by turbogenerator 212 (not shown). In some embodiments, pump 520 comprises an auxiliary power supply, such as a battery system. In some embodiments, convective flow is sufficient to ensure circulation of working fluid 216 through closed-loop conduit 504 and pump 520 is not included.

Working fluid 510 is thermally coupled with cold zone 512. As a result, working fluid 510 is thermally coupled with water in deep water region 230.

It is an aspect of some embodiments of the present invention that the water at a deep level of an ocean or similar body of water provides a heat sink with sufficient heat capacity to enable it to maintain a substantially constant temperature at all times. It is well-known that ocean temperatures drop with depth. For example, tropical and semi-tropical ocean temperatures at depths of 500, 700, and 1000 meters remain substantially constant at 12, 8, and 4° C., respectively. Deep water levels, therefore, have a heat-sink capability that is well-suited to the present invention.

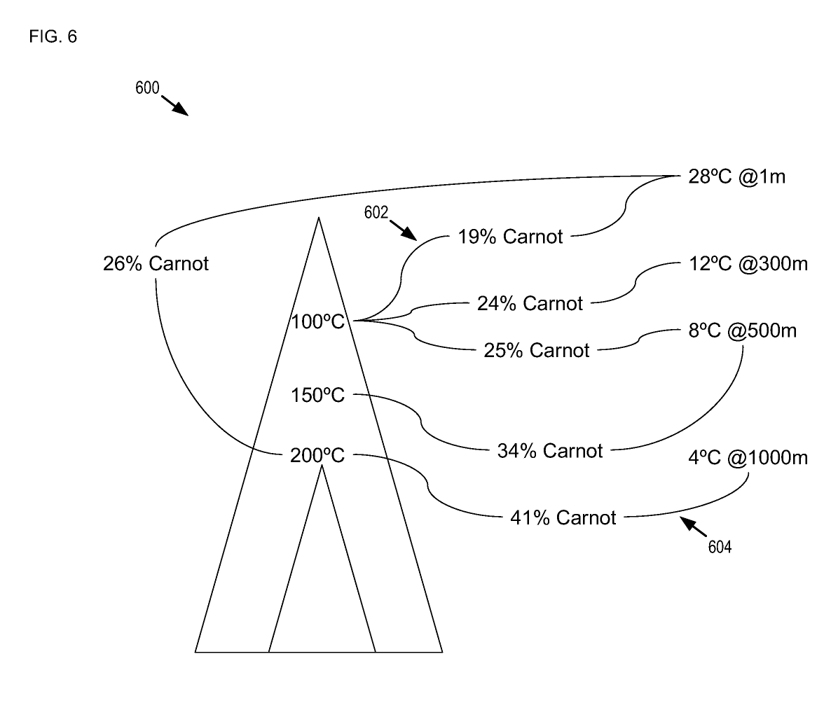

FIG. 6 depicts calculated efficiencies of energy conversion cycles versus temperature differential for an energy conversion system in accordance with the present invention. Plot 600 depicts Carnot cycle conversion efficiency for a range of temperature differentials that are based on water depths and geothermal heat source temperatures (i.e., the temperature of petroleum products flowing through regions 320). As one skilled in the art will recognize, the Carnot cycle represents the most efficient cycle possible for converting a given amount of thermal energy into work.

Conversion cycle 602 depicts the efficiency for a thermoelectric energy conversion system based on the temperature differential between surface water (i.e., 1 m deep having a temperature of approximately 28° C.) and a relatively cool geothermal source (having a temperature of 100° C.). Although the systems in accordance with the present invention are operable for smaller temperature differentials, in some embodiments of the present invention, the temperature differential for conversion cycle 602 represents the smallest reasonable temperature cycle commonly available using a geothermal heat source. The energy conversion efficiency of conversion cycle 602 is a modest 19% of the Carnot cycle.

Conversion cycle 604, on the other hand, represents the largest temperature cycle commonly available using a geothermal heat source. Conversion cycle 604 is based on the temperature difference between water at 1000 m depth (having a temperature of approximately 6° C.) and a hot geothermal source (having a temperature of approximately 200° C.), the energy conversion efficiency is approximately 61% of the Carnot cycle. Conversion cycle 604, therefore, is characterized by a conversion efficiency that is 22% greater than that of conversion cycle 602. This represents an efficiency improvement of more than 100%.

In some embodiments, sufficient heat is removed from the petroleum products flowing through region 320 (by virtue of working fluids 216 and 510) to significantly decrease its temperature. In some embodiments, enough heat is removed that the temperature of the petroleum products in region 322 is lower than the temperature of the petroleum products in region 318 by 100° C. or more. This dramatic reduction in temperature can reduce the corrosive nature of the material in conduits 308 and 306 such that at least a portion of these conduits can be made from substantially conventional materials. As a result, the expense and complexity of conduits comprising specialized materials such as duplex stainless-steel, corrosion-resistant alloys, and the like is avoided.

In addition to reducing the temperature of the oil flowing through region 320, the dissipation of heat from the working fluid at heat exchanger 506 serves to enhance the circulation of the working fluid through closed-loop conduit 504. In some embodiments, this circulation is sufficient to obviate the need for pump 520.

At operation 405, electrical energy generated by turbogenerator 212 is conveyed to pump 312 on cable 314. Since energy conversion system 310 and pump 312 are located in close proximity to one another, embodiments of the present invention do not incur the power loss that typically occurs in long cables used to convey electrical energy between the ocean surface and deep water region 230. In addition, kilometer+ lengths of electrical cable, adapted for use in ocean environments, are not required. This further reduces the cost and complexity of embodiments of the present invention as compared to prior-art systems.

At operation 406, pumps 312 pump hot oil from geothermal reservoir 104 into feeder conduits 308 and petroleum conduit 306.

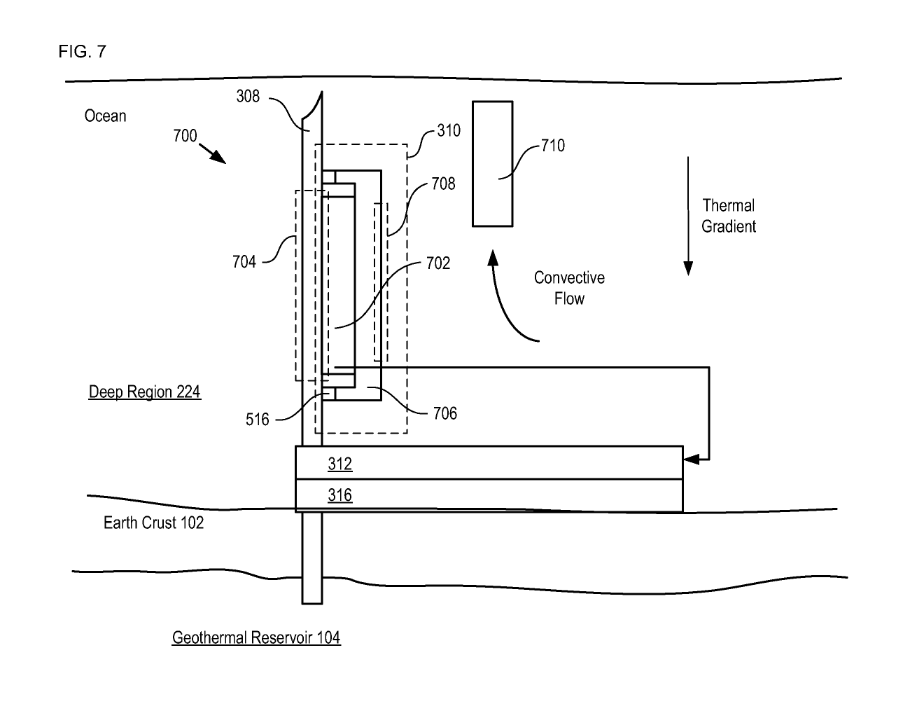

FIG. 7 depicts a schematic diagram of details of a self-powered pump system in accordance with a first alternative embodiment of the present invention. Pump system 700 comprises thermo-electric element 702, hot zone 704, pressure hull 706, cold zone 708, and chimney 710.

Thermo-electric element 702 comprises a bismuth-telluride alloy that generates an open-circuit voltage in response to a thermal gradient placed across it. Commercial examples of thermo-electric element 702 include HZ modules available from Hi-Z Technology, Inc.

In some embodiments, thermo-electric element 702 is a solid-state element that generates electrical energy by means of the Peltier effect.

Hot zone 704 and cold zone 708 are analogous to hot zone 514 and cold zone 512, as described above and with respect to FIG. 5. Cold zone 708 comprises a portion of pressure hull 706, which is analogous to pressure hull 516.

In some embodiments, convective flow of cold water across cold zone 708 is constrained by chimney 710, thereby facilitating heat flow between the heat exchanger and seawater. The length of the chimney 710 would be designed to account for the temperature difference between the convecting seawater as it passes by cold zone 708 and the depth of the average thermocline at that temperature. The heat sink included in cold zone 708 would be designed to exhibit less head loss than the pressure difference (inside and outside) at the bottom of the chimney 710, minus the fluid drag up the chimney 710. In some embodiments, chimney 710 is not used since the rate at which the convective flow of cold water flows across cold zone 708 is sufficient to ensure that the ambient temperature of the water in the local area of cold zone 708 does not substantially increase during operation of thermo-electric generator 700.

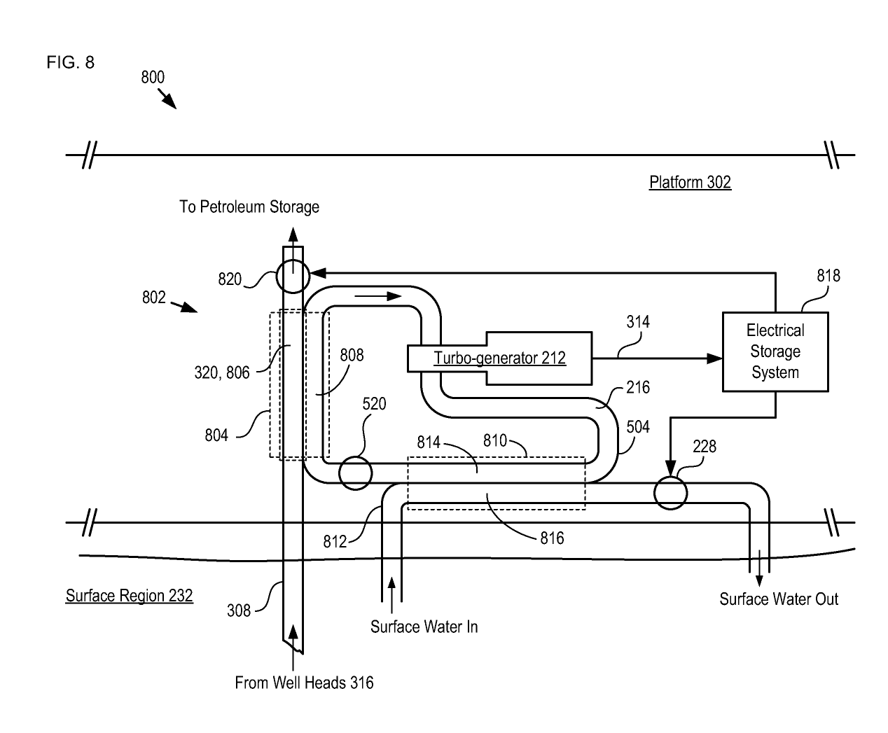

FIG. 8 depicts a schematic diagram of details of a self-powered pump system in accordance with a second alternative embodiment of the present invention. Pump system 800 comprises platform 302, energy conversion system 802, and electrical energy storage system 818. Energy conversion system 802 and electrical energy storage system 818 are located on platform 302.

Energy conversion system 802 is analogous to energy conversion systems 310; however, energy conversion system 802 is located at the surface of the body of water. Because of the high temperature difference between the petroleum products and the temperature of the surface water, energy conversion system 802 can operate effectively without adaptation for deep-level operation. As depicted in FIG. 6, conversion efficiency as high as 19% can be achieved using surface water at a temperature of approximately 28° C. The operation of energy conversion system 802 is analogous to the operation of energy conversion system 310, described above, as well as that described in detail in U.S. patent application Ser. No. 12/411,824, which is incorporated herein by reference.

Heat exchanger 804 portion 808 of closed-loop conduit 504 comprises and hot zone 806. Hot zone 806 is region 320 of feeder conduit 308, which is thermally coupled with closed-loop conduit 504. As a result, at heat exchanger 804, working fluid 216 in portion 808 is thermally coupled with hot petroleum product pumped from geothermal reservoir 104.

Heat exchanger 810 comprises portion 814 of closed-loop conduit 504 and cold zone 816. Cold zone 816 is a region of surface water conduit 812, which is thermally coupled with portion 814. As a result, at heat exchanger 810, working fluid 216 in portion 814 is thermally coupled with cold surface water pumped from surface region 232. The cold surface water in surface water conduit 812 sinks sufficient heat from working fluid 216 at heat exchanger 810 to condense vaporized working fluid into its liquid state.

Surface water conduit 812 is analogous to surface water conduit 204 described above and with respect to FIG. 2. Surface water conduit 812, however, draws surface water from region 818 and ejects it to region 820, which is located far enough away from region 818 that the water drawn by surface water conduit 204 remains cool enough to condense working fluid 216 at heat exchanger 810.

Electrical energy generated by energy conversion system 802 is provided to electrical storage system 818. In some embodiments, electrical energy storage system provides the energy that drives pump 820, which pumps petroleum products from well heads 316 to one or more petroleum storage tanks or oil tankers. In some embodiments, the electrical energy generated by energy conversion system 802 is used to power some or all of the facilities located on platform 302.

By virtue of its use of water from surface region 232 in its condenser (i.e., heat exchanger 810), system 800 obviates the need for an expensive deep water conduit, such as conduit 280, described above and with respect to FIG. 2. As a result, system 800 can provide electrical energy without some of the expense and complexity of prior-art OTEC systems. In addition, since system 800 comprises a petroleum pump located on platform 302, pump 820 is powered locally and system 800 derives some or all of the advantages of a locally powered submerged self-powered petroleum pump. Further, energy conversion system 802 enables local power for other facility infrastructure in addition to, or instead of, pump 820.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An apparatus comprising:
a first conduit, wherein the first conduit conveys a petroleum product from a geothermal reservoir through a first conduit region; and
an energy conversion system that generates electrical energy based on a first temperature differential between the first conduit region and water from a first region of a body of water.

2. The apparatus of claim 1 wherein the energy conversion system further comprises:
a hot zone that comprises the first conduit region, wherein the first conduit region is thermally coupled to the petroleum product; and
a cold zone that is thermally coupled to the water from the first region of the body of water;
wherein the temperature of the hot zone and the temperature of the cold zone define a second temperature differential that is based on the first temperature differential, and wherein the energy conversion system is thermally coupled to the hot zone and the cold zone; and further wherein the energy conversion system generates electrical energy based on the second temperature differential.

3. The apparatus of claim 1 wherein the apparatus further comprises a pump that pumps the petroleum product from the subterranean reservoir through the first conduit region, and wherein the energy conversion system provides electrical energy to the pump.

4. The apparatus of claim 3 wherein the pump is physically adapted for operation in a deep sea environment.

5. The apparatus of claim 1 wherein the first conduit comprises a second conduit region that is duplex stainless-steel-free.

6. The apparatus of claim 1 wherein the first conduit comprises a second conduit region that is corrosion-resistant alloy-free.

7. The apparatus of claim 1 wherein the first conduit further comprises a second conduit region and a third conduit region, and wherein the first conduit region interposes the second conduit region and the third conduit region, and further wherein the energy conversion system sinks heat from the first conduit region such that the temperature of the petroleum products in the third conduit region is at least 100° C. lower than the temperature of the petroleum products in the second conduit region.

8. The apparatus of claim 1 wherein the energy conversion system comprises a Rankine-cycle engine.

9. The apparatus of claim 1 wherein the energy conversion system comprises a solid-state thermo-electric element.

10. The apparatus of claim 9 wherein the thermo-electric element generates electrical energy by means of the Peltier effect.

11. The apparatus of claim 9 wherein the thermo-electric element comprises a quantum-well energy conversion system.

12. An apparatus comprising an energy conversion system that generates electrical energy based on a temperature differential between a first conduit region and water from a first region of a body of water, wherein the first conduit region is thermally coupled to a petroleum product from a geothermal reservoir, and wherein the petroleum product is cooled by at least 100° C. as it traverses the first conduit region.

13. The apparatus of claim 12 further comprising a pump for pumping the petroleum product, wherein the energy conversion system provides electrical energy to the pump.

14. The apparatus of claim 13 wherein the pump is physically adapted for operation in a deep sea environment.

15. The apparatus of claim 12 wherein the energy conversion system comprises a Rankine-cycle engine.

16. The apparatus of claim 12 wherein the energy conversion system comprises a solid-state thermo-electric element.

17. A method comprising:
conveying a petroleum product from a subterranean reservoir through a first conduit region of a first conduit;
thermally coupling the first conduit region and the petroleum product;
thermally coupling the first conduit region and an energy conversion system;
thermally coupling water from a first region of a body of water to the energy conversion system; and
generating electrical energy based on a temperature differential between the first conduit region and the water.

18. The method of claim 17 further comprising:
conveying the petroleum product through the first conduit region from a second conduit region of the first conduit to a third conduit region of the first conduit; and
removing heat from the petroleum product in the first conduit region such that the temperature of the petroleum product is at least 100° C. lower in the third conduit region than in the first conduit region.

19. The method of claim 17 further comprising providing the generated electrical energy to a pump, wherein the pump pumps the petroleum product through the first conduit.

20. The method of claim 19 further comprising providing the pump, wherein the pump is physically adapted for operation in a deep-sea environment.

21. The method of claim 17 wherein the electrical energy is generated by a Rankine-cycle engine that is thermally coupled to a hot zone and a cold zone, and wherein the hot zone comprises the first conduit region, and further wherein the cold zone is thermally coupled to the water.

22. The method of claim 17 wherein the electrical energy is generated by a solid-state thermo-electric device that is thermally coupled to a hot zone and a cold zone, and wherein the hot zone comprises the first conduit region, and further wherein the cold zone is thermally coupled to the water.
